(19) United States
(12) Patent Application Publication
(10) Pub. No.: US 2025/0293427 A1
(43) Pub. Date: Sep. 18, 2025

(54) THREE-DIMENSIONAL (3D) WIRELESS MULTIBANK ANTENNA FOR SECURITY GATEWAY

(71) Applicant: Lap Tak Tang, Hong Kong (CN)

(72) Inventor: Lap Tak Tang, Hong Kong (CN)

(21) Appl. No.: 19/092,678

(22) Filed: Mar. 27, 2025

(30) Foreign Application Priority Data
Mar. 25, 2025 (CN) 202520537069.1

(51) Int. Cl. H01Q 1/44; G08B 3/10; H01Q 1/22; H01Q 1/24

(52) U.S. Cl. CPC H01Q 1/44; G08B 3/1016; H01Q 1/2291; H01Q 1/241

(57) ABSTRACT

A three-dimensional (3D) wireless multiband antenna for security gateway, including an antenna carrier assembly, a plurality of 3D antennas and an audio assembly. The plurality of 3D antennas are provided spaced apart on the antenna carrier assembly. The audio assembly is connected with the antenna carrier assembly, and the antenna carrier assembly and the audio assembly enclose a mounting hole. The mounting hole is configured to mount the security gateway.

### CROSS-REFERENCE TO RELATED APPLICATIONS

This application claims the benefit of priority from Chinese Patent Application No. 202520537069.1, filed on Mar. 25, 2025. The content of the aforementioned application, including any intervening amendments thereto, is incorporated herein by reference in its entirety.

### TECHNICAL FIELD

This application relates to security gateway technologies, and more particularly to a three-dimensional (3D) wireless multiband antenna for security gateway.

### BACKGROUND

Security gateways usually integrate wireless circuits, such as cellular communication module, WiFi, Bluetooth, Z-wave, and low frequency industrial, scientific, and medical (ISM) band modules for external sensors. These gateways generally incorporate antennas to enable wireless communication with external devices. However, integrating multiple antennas poses design challenges because numerous components will emit electromagnetic interference (EMI). A close arrangement or direct contact between antennas will significantly complicate the isolation of other integrated components, thereby increasing the risk of mutual interference.

The normal operation of the antennas in the security gateway may be affected in the presence of excessive external components. In addition, material composition of the wall can also affect performances of the antenna. For example, metal structures embedded in concrete or other materials may interfere with the normal operation of the antennas. The interference from the wall material or excessive external noise will significantly attenuate wireless performances of the security gateway.

In addition, inconsistent manufacturing processes or manual assembly errors may also adversely influence the antenna performances.

### SUMMARY

In view of this, it is necessary to provide a three-dimensional (3D) wireless multiband antenna for security gateway to overcome the defects in the prior art.

A three-dimensional (3D) wireless multiband antenna for security gateway is provided, comprising:
an antenna carrier assembly;
a plurality of 3D antennas; and
an audio assembly;
wherein the plurality of 3D antennas are provided spaced apart on the antenna carrier assembly; and
the audio assembly is connected with the antenna carrier assembly, and the antenna carrier assembly and the audio assembly are configured to enclose a mounting hole; and the mounting hole is configured to mount the security gateway.

In an embodiment, the each of the plurality of 3D antennas comprises a main body and a fixing component; the main body is connected with the antenna carrier assembly; a top of the antenna carrier assembly is provided with a first positioning column; the fixing component is provided with a first positioning hole; and the first positioning column is configured to be inserted into the first positioning hole, so as to realize positioning of the plurality of 3D antennas on the antenna carrier assembly.

In an embodiment, the fixing component comprises a first connecting part, a second connecting part and a third connecting part connected in sequence; and
the first connecting part is configured to extend from an end of the first connecting part connected with the main body along a first direction to be connected with the second connecting part; the first positioning hole is provided on the first connecting part; the second connecting part is configured to extend from an end of the first connecting part away from the main body along a second direction to be connected with the third connecting part; the third connecting part is configured to extend from an end of the second connecting part away from the first connecting part along a third direction; the first direction is opposite to the third direction; the second direction is perpendicular to the first direction; the first connecting part, the second connecting part and the third connecting part are configured to enclose a limit space; and the antenna carrier assembly is configured to be partially clamped into the limit space.

In an embodiment, each of the plurality of 3D antennas further comprises a fitting component; the fitting component is provided on a side of the main body away from the fixing component; and the fitting component is configured to fit a side of the antenna carrier assembly.

In an embodiment, the top of the antenna carrier assembly is further provided with a second positioning column spaced apart from the first positioning column; the main body is provided with a second positioning hole; and the second positioning column is configured to be inserted into the second positioning hole.

In an embodiment, the plurality of 3D antennas comprise a long-term evolution (LTE) antenna, a wireless fidelity (WIFI) antenna, a Z-wave internet of things (ZWAVE IOT) antenna and a sub-gigahertz radio frequency (SubG RF) antenna.

In an embodiment, the antenna carrier assembly comprises a first carrier, a second carrier and a third carrier; the second carrier is arranged between the first carrier and the third carrier; the first carrier is perpendicularly provided at a first end of the second carrier, and the third carrier is perpendicularly provided at a second end of the second carrier; and the plurality of 3D antennas are provided along the first carrier, the second carrier and the third carrier spaced apart from each other.

In an embodiment, a first end of the audio assembly is provided with a first fastening hole, and a second end of the audio assembly is provided with a second fastening hole; the antenna carrier assembly is provided with a first fastening component and a second fastening component; the first fastening component is provided on an end of the first carrier away from the second carrier; the second fastening component is provided on an end of the third carrier away from the second carrier; the first fastening component is provided in the first fastening hole; and the second fastening component is provided in the second fastening hole.

In an embodiment, the antenna carrier assembly is provided with an antenna contact spring; a bottom of each of the plurality of 3D antennas is provided with an antenna feed point; and the antenna feed point is in contact with the antenna contact spring.

In an embodiment, the 3D wireless multiband antenna further comprises an audio alarm; and the audio alarm is provided on the audio assembly.

In an embodiment, the audio alarm comprises a resonator, a piezoelectric buzzer and a housing; the resonator is provided on a side of the audio assembly; the piezoelectric buzzer is provided on a side of the resonator; and the housing is provided between the piezoelectric buzzer and the resonator.

Regarding the 3D wireless multiband antenna provided herein, multiple 3D antennas are integrated onto the antenna carrier assembly to save a design space and reach a compact size. Besides, the plurality of 3D antennas fit closely to the antenna carrier assembly, so that the antenna carrier assembly can serve as an electromagnetic shield to reduce external electromagnetic interference. The 3D wireless multiband antenna of this application is suitable for the automated assembly, so as to avoid the errors from manual assembly. Moreover, through the arrangement of the plurality of 3D antennas, the penetration performance is enhanced.

### BRIEF DESCRIPTION OF THE DRAWINGS

In order to illustrate the technical solutions of this application or the prior art more clearly, the accompanying drawings required in the description of embodiments or the prior art will be briefly introduced below. It is obvious that the following accompanying drawings only show some embodiments of this application, and for those of ordinary skill in the art, other relevant accompanying drawings can also be obtained according to these drawings without making creative effort.

FIG. 1 is a structural diagram of a three-dimensional (3D) wireless multiband antenna according to an embodiment of the present disclosure.

FIG. 2 is a top view of the 3D wireless multiband antenna according to an embodiment of the present disclosure.

FIG. 3 is a structural diagram of an antenna carrier assembly according to an embodiment of the present disclosure.

FIG. 4 is an enlarged view of portion “A” in FIG. 3.

FIG. 5 is a structural diagram of a 3D antenna according to an embodiment of the present disclosure.

FIG. 6 is an enlarged view of portion “B” in FIG. 5.

FIG. 7 is a structural diagram of the 3D antenna according to another embodiment of the present disclosure.

FIG. 8 is a sectional view of an audio alarm according to an embodiment of the present disclosure.

FIG. 9 is a bottom view of the 3D wireless multiband antenna according to another embodiment of the present disclosure.

FIG. 10 is an enlarged view of portion “A” in FIG. 9.

FIG. 11 is an enlarged view of portion “B” in FIG. 9.

FIG. 12 is a bottom view of an audio assembly of the 3D wireless multiband antenna in FIG. 9.

FIG. 13 is a structural diagram of the antenna carrier assembly of the 3D wireless multiband antenna in FIG. 9.

In figures: 1, antenna carrier assembly; 11, first carrier; 12, second carrier; 13, third carrier; 14, first fastening component; 15, second fastening component;
2, three-dimensional (3D) antenna; 21, main body; 22, fixing component; 23, first positioning hole; 24, first connecting part; 25, second connecting part; 26, third connecting part; 27, second positioning hole; 28, fitting component;
3, audio assembly; 31, audio alarm; 32, resonator; 33, piezoelectric buzzer; 34, housing; 35, first fastening hole; 36, second fastening hole; 37, first audio body; 38, second audio body; and
4, mounting hole; 5, first positioning column; and 6, second positioning column.

The realization of the objects, functional characteristics and advantages of the present disclosure will be further described below with reference to the embodiments and accompanying drawings.

### DETAILED DESCRIPTION OF EMBODIMENTS

The technical solutions of the embodiments of the present disclosure will be clearly and completely described with reference to the accompanying drawings of the embodiments of the present disclosure. It is obvious that described herein are only some embodiments of the present disclosure, rather than all embodiments. Based on the embodiments provided herein, other embodiments obtained by those of ordinary skill in the art without making creative effort shall fall within the scope of the present disclosure.

It should be noted that the terms, such as “up”, “down”, “left”, “right”, “front”, “rear” and other directional indications used herein, are only used for illustrating relative position relationship and motion between components in a specific state (as shown in the accompanying drawings). If the specific state changes, the directional indication accordingly changes.

In addition, the terms “first” and “second” are only used for distinguishment rather than indicating or implying the relative importance or implicitly specifying the number of technical features indicated. Therefore, a feature defined with “first” or “second” may explicitly or implicitly indicates the inclusion of at least one of such features. Besides, the term “and/or” used herein includes three solutions, for example, “A” and/or “B” includes solution “A”, solution “B”, and a combination thereof. Technical solutions of embodiments can be combined with each other as long as the combined solution can be implemented by those skilled in the art. When a combination of the technical solutions is contradictory or cannot be realized, it should be considered that such a combination does not exist, and is not within the scope of the present disclosure.

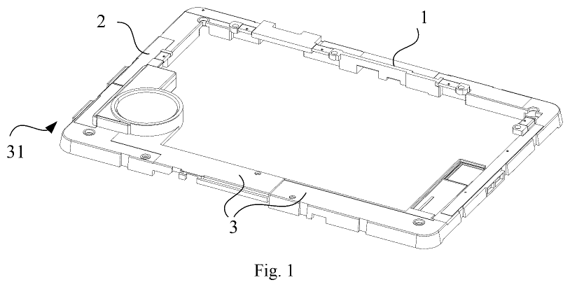

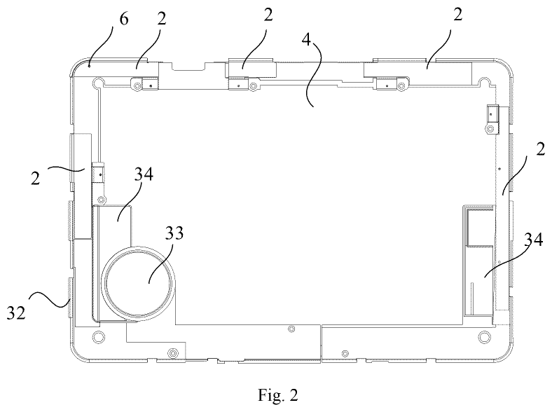

Referring to FIGS. 1-2, a three-dimensional (3D) wireless multiband antenna for security gateway includes an antenna carrier assembly 1, a plurality of 3D antennas 2 and an audio assembly 3. The plurality of 3D antennas 2 are provided on the antenna carrier assembly 1 spaced apart on the antenna carrier assembly. The audio assembly 3 is connected with the antenna carrier assembly 1, and the antenna carrier assembly 1 and the audio assembly 3 are configured to enclose a mounting hole 4. The mounting hole 4 is configured to mount the security gateway.

The present disclosure provides the 3D wireless multiband antenna for security gateway, the plurality of 3D antennas 2 are integrated and arranged on the antenna carrier assembly 1 through providing the antenna carrier assembly 1, which saves design room and makes it have a compact external size. The plurality of 3D antennas 2 abut against the antenna carrier assembly 1, and the antenna carrier assembly 1 itself can serve as an electromagnetic shielding material, which reduces external electromagnetic interference. The 3D wireless multiband antenna of the present disclosure can realize automated assembly, avoiding affects on antennas caused by errors during manual assembly. The present disclosure also provides the plurality of 3D antennas 2 to enhance penetration by increasing the number of 3D antennas.

In an embodiment, the antenna carrier assembly 1 is made of a metal material.

In an embodiment, the 3D wireless multiband antenna of the present disclosure is applicable to the security gateway. The antenna carrier assembly 1 is connected with a shell of the security gateway through a plurality of screws. The security gateway is equipped with one or more processors and one or more memories for storing or temporarily storing data and instructions required by s running program or an operating system. The operating system receives information and instructions from neighboring devices on different channels through the plurality of 3D antennas 2, and accordingly executes corresponding programs.

The security gateway is equipped with a radio frequency (RF) multi-band antenna. The antenna carrier assembly 1 is integrated with an external structure, such as a housing component, which can effectively improve performance of antennas and make devices maintain high efficiency when devices are mounted into the housing component.

The plurality of 3D antennas 2 are composed of a resonant element on a flexible printed circuit board. The resonant element is arranged on the antenna carrier assembly 1, and is connected with a support structure through a spring-type connector.

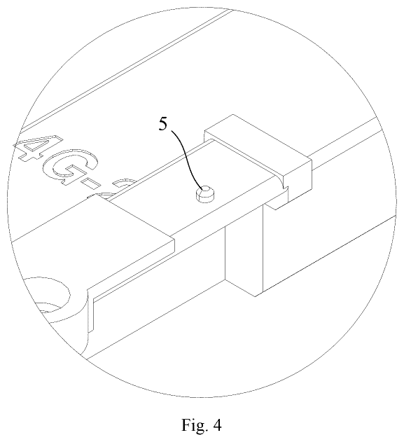

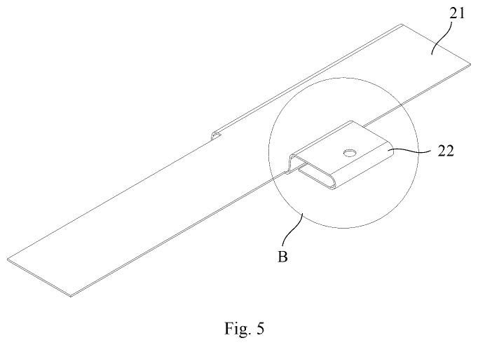

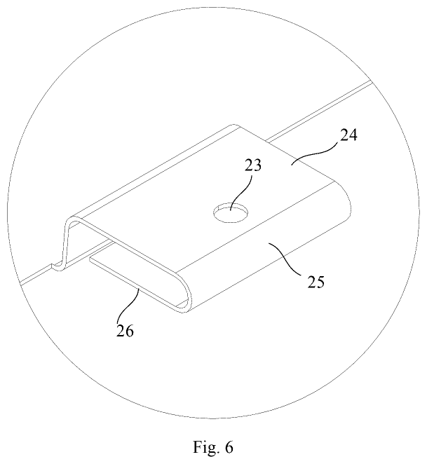

Referring to FIGS. 4-7, each of the plurality of 3D antennas 2 includes a main body 21 and a fixing component 22 connected with the main body. The main body 21 is connected with the antenna carrier assembly 1. Atop of the antenna carrier assembly 1 is provided with a first positioning column 5. The fixing component 22 is provided with a first positioning hole 23. The first positioning column 5 is configured to be inserted into the first positioning hole 23 to realize positioning of the plurality of 3D antennas 2 on the antenna carrier assembly 1.

In an embodiment, the plurality of 3D antennas 2 are engraved on the antenna carrier assembly 1. Positioning is realized through the first positioning column 5, which is convenient for assembly and positioning and saves mounting time.

Current security gateways are generally designed through flexible printed circuit (FPC). The FPC needs to be pasted on a non-metallic housing, which requires a certain degree of flatness and cleanliness on a surface of a device. Once there is an error in a pasting position or mounting angle of the FPC, a receiving effect and performance of the antennas will be affected. Besides, during a process of mounting the antennas on the FPC, if the antennas are bent or squeezed, the antennas may deform or get damaged, which may affect electrical performance and mechanical strength of the antennas. The present disclosure provides the antenna carrier assembly 1, and the plurality of 3D antennas 2 are arranged on the antenna carrier assembly 1, in this way, the plurality of 3D antennas 2 have a compact external size, and automated assembly is realized, which avoids affects on antennas caused by errors during manual assembly.

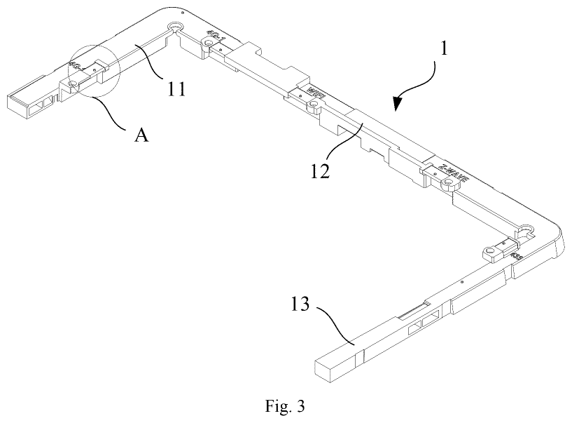

Referring to FIGS. 3-7, the fixing component 22 includes a first connecting part 24, a second connecting part 25 and a third connecting part 26 connected in sequence. The first connecting part 24 is configured to extend from an end of the first connecting part 24 connected with the main body 21 along a first direction to be connected with the second connecting part 25. The first positioning hole 23 is provided on the first connecting part 24. The second connecting part 25 is configured to extend from an end of the first connecting part 24 away from the main body 21 along a second direction to be connected with the third connecting part 26. The third connecting part 26 is configured to extend from an end of the second connecting part 25 away from the first connecting part 26 along a third direction. The first direction is opposite to the third direction. The second direction is perpendicular to the first direction. The first connecting part 24, the second connecting part 25 and the third connecting part 26 are configured to enclose a limit space. The antenna carrier assembly 1 is configured to be partially clamped into the limit space.

In an embodiment, the first direction is a rightward direction along a length direction of the antenna carrier assembly 1, the second direction is a downward direction along a width direction of the antenna carrier assembly 1, and the third direction is a leftward direction along the length direction of the antenna carrier assembly 1.

In an embodiment, the limit space has a C-shaped structure. The antenna carrier assembly 1 is configured to be partially clamped into the limit space, the C-shaped structure is configured to effectively clamp a part of the antenna carrier assembly 1, which further realizes a fixed stability between the plurality of 3D antennas 2 and the antenna carrier assembly 1.

Referring to FIGS. 1-3, the top of the antenna carrier assembly 1 is further provided with a second positioning column 6 spaced apart from the first positioning column 5. The main body 21 is provided with a second positioning hole 27. The second positioning column 6 is configured to be inserted into the second positioning hole 27, which further improves assembly positioning between the plurality of 3D antennas 2 and the antenna carrier assembly 1.

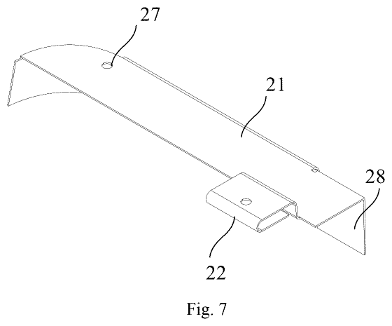

Referring to FIG. 7, each of the plurality of 3D antennas 2 further includes an fitting component 28. The fitting component 28 is provided on a side of the main body 21 away from the fixing component 22. The fitting component 28 is configured to fit a side of the antenna carrier assembly.

In an embodiment, a side of the antenna carrier assembly 1 is coated with a double-sided tape. The fitting component 28 is configured to fit the side of the main body 21 through the double-sided tape.

In an embodiment, the fitting component 28 is formed by extending along the second direction from the side of the main body 21 away from the fixing component 22.

Referring to FIGS. 1-3, the plurality of 3D antennas 2 include a long-term evolution (LTE) antenna, a wireless fidelity (WIFI) antenna, a Z-wave internet of things (ZWAVE IOT) antenna and a sub-gigahertz radio frequency (SubG RF) antenna. The multiband antenna of the present disclosure supports dual bands of WiFi 2.4 GHz and 5 GHz, LTE, Bluetooth, Z-Wave and Sub-G radio frequency bands. An antenna structure can be designed to an integrated radio frequency (RF) radiation element within a mounting mechanism of electronic devices.

Referring to FIGS. 1-3, the antenna carrier assembly 1 includes a first carrier 11, a second carrier 12 and a third carrier 13. The second carrier 12 is arranged between the first carrier 11 and the third carrier 13 The first carrier 11 perpendicularly provided at a first end of the second carrier 12, and the third carrier 13 is perpendicularly provided at a second end of the second carrier 12. The plurality of 3D antennas 2 are provided spaced apart along the first carrier 11, the second carrier 12 and the third carrier 13 spaced apart from each other.

In an embodiment, the first carrier 11, the second carrier 12 and the third carrier 13 are integratedly provided.

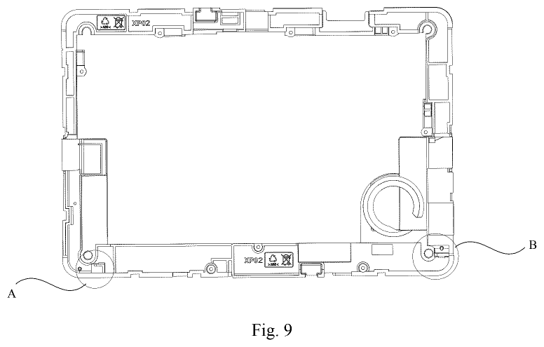

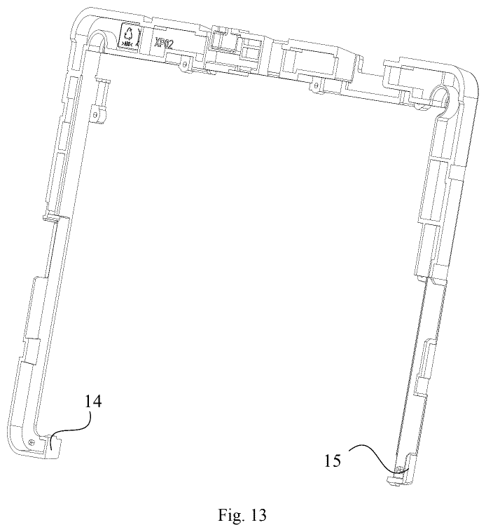

In an embodiment, referring to FIGS. 9-13, a first end of the audio assembly 3 is provided with a first fastening hole 35, and a second end of the audio assembly 3 is provided with a second fastening hole 36. The antenna carrier assembly 1 is provided with a first fastening component 14 and a second fastening component 15. The first fastening component 14 is provided on an end of the first carrier 11 away from the second carrier 12. The second fastening component 15 is provided on an end of the third carrier 13 away from the second carrier 12. The first fastening component 14 is provided in the first fastening hole 35. The second fastening component 15 is provided in the second fastening hole 36.

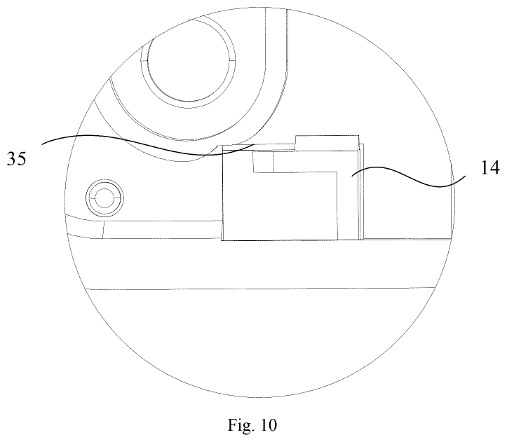

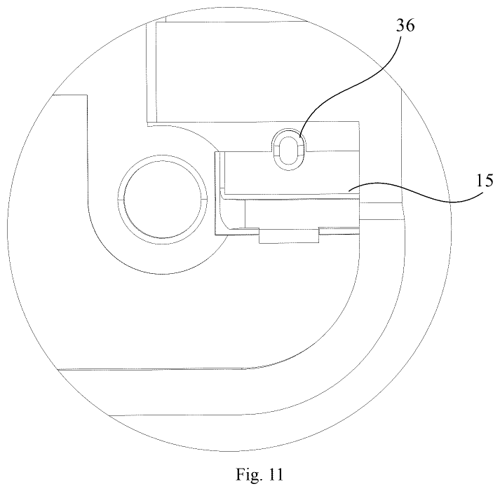

In an embodiment, FIG. 10 shows a situation where the first fastening component 14 is engaged with the first fastening hole 35. The first fastening component 14 is engaged in the first fastening hole 35 through elastic deformation. FIG. 11 shows a situation where the second fastening component 15 is engaged with the second fastening hole 36. The second fastening component 15 is engaged in the second fastening hole 36 through elastic deformation.

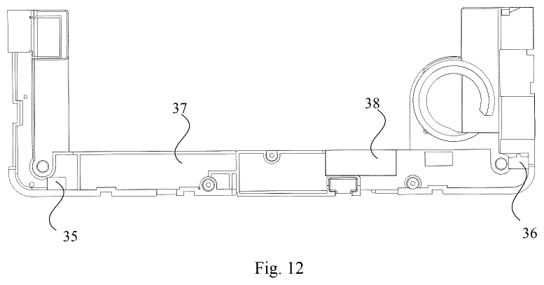

Referring to FIG. 12, in this embodiment, the audio assembly 3 has a split structure including a first audio body 37 and a second audio body 38. The first audio body 37 is connected with the second audio body 38 to form the audio assembly 3.

In this embodiment, the LTE antenna is a LTE (4G/5G) antenna, and the number of the LTE antenna is two. One of the two LTE antennas is provided on the first carrier 11, and the other one of the two LTE antennas is provided on the second carrier 12. The WIFI antenna is provided on the second carrier 12. The ZWAVE IOT antenna is provided on the second carrier 12. The SubG RF antenna is provided on the third carrier 13. In the present disclosure, signals can be received and sent at different angles through providing the plurality of 3D antennas 2 at different angles. In this way, though a signal of one antenna is attenuated due to obstacles, such as walls and buildings, or other factors, other 3D antennas 2 can receive stronger signals at different angles, avoiding weak current of a single signal source, which is helpful to improve receiving quality of signals, enhance anti-interference ability, and improve the penetration.

Referring to FIG. 1, the antenna carrier assembly 1 is provided with an antenna contact spring. A bottom of each of the plurality of 3D antennas 2 is provided with an antenna feed point. The antenna feed point is in contact with the antenna contact spring.

In an embodiment, the antenna feed point is in contact connection with the antenna contact spring, in this way, the antenna feed point is not easy to loosen and has a characteristic of stable connection.

Referring to FIGS. 1-2, the 3D wireless multiband antenna of the present disclosure further includes an audio alarm 31, and the audio alarm 31 is provided on the audio assembly 3.

The audio alarm 31 includes a resonator 32, a piezoelectric buzzer 33 and a housing 34. The resonator 32 is provided on a side of the audio assembly 3. The piezoelectric buzzer 33 is provided on a side of the resonator 32. The housing 34 is provided between the piezoelectric buzzer 33 and the resonator 32.

In an embodiment, the number of the housing 34 is two, and the two housings 34 are provided opposite each other. One of the two housings 34 is ultrasonically welded between the piezoelectric buzzer 33 and the resonator 32. The other one of the two housings 34 is ultrasonically welded on a side of the audio assembly 3 away from the resonator 32.

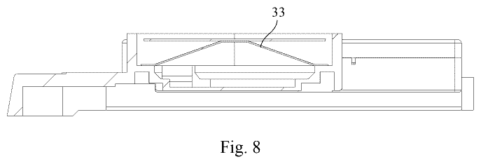

Referring to FIG. 8, when the security gateway detects a security risk, the piezoelectric buzzer 33 vibrates to drive the resonator 32 to produce sound.

Described above are only preferred embodiments of the present disclosure, which are not intended to limit the disclosure. It should be understood that various modifications, changes and replacements made by those skilled in the art without departing from the spirit of the disclosure shall fall within the scope of this application defined by the appended claims.

What is claimed is:

1. A three-dimensional (3D) wireless multiband antenna for a security gateway, comprising:
an antenna carrier assembly;
a plurality of 3D antennas; and
an audio assembly;
wherein the plurality of 3D antennas are provided spaced apart on the antenna carrier assembly; and
the audio assembly is connected with the antenna carrier assembly, and the antenna carrier assembly and the audio assembly are configured to enclose a mounting hole; and the mounting hole is configured to mount the security gateway.

2. The 3D wireless multiband antenna of claim 1, wherein each of the plurality of 3D antennas comprises a main body and a fixing component connected with the main body; the main body is connected with the antenna carrier assembly; a top of the antenna carrier assembly is provided with a first positioning column; the fixing component is provided with a first positioning hole; and the first positioning column is configured to be inserted into the first positioning hole to realize positioning of the plurality of 3D antennas on the antenna carrier assembly.

3. The 3D wireless multiband antenna of claim 2, wherein the fixing component comprises a first connecting part, a second connecting part and a third connecting part connected in sequence; and
the first connecting part is configured to extend from an end of the first connecting part connected with the main body along a first direction to be connected with the second connecting part; the first positioning hole is provided on the first connecting part; the second connecting part is configured to extend from an end of the first connecting part away from the main body along a second direction to be connected with the third connecting part; the third connecting part is configured to extend from an end of the second connecting part away from the first connecting part along a third direction; the first direction is opposite to the third direction; the second direction is perpendicular to the first direction; the first connecting part, the second connecting part and the third connecting part are configured to enclose a limit space; and the antenna carrier assembly is configured to be partially clamped into the limit space.

4. The 3D wireless multiband antenna of claim 3, wherein each of the plurality of 3D antennas further comprises a fitting component; the fitting component is provided on a side of the main body away from the fixing component; and the fitting component is configured to fit a side of the antenna carrier assembly.

5. The 3D wireless multiband antenna of claim 2, wherein the top of the antenna carrier assembly is further provided with a second positioning column spaced apart from the first positioning column; the main body is provided with a second positioning hole; and the second positioning column is configured to be inserted into the second positioning hole.

6. The 3D wireless multiband antenna of claim 1, wherein the plurality of 3D antennas comprise a long-term evolution (LTE) antenna, a wireless fidelity (WIFI) antenna, a Z-wave internet of things (ZWAVE IOT) antenna and a sub-gigahertz radio frequency (SubG RF) antenna.

7. The 3D wireless multiband antenna of claim 1, wherein the antenna carrier assembly comprises a first carrier, a second carrier and a third carrier; the second carrier is arranged between the first carrier and the third carrier; the first carrier is perpendicularly provided at a first end of the second carrier, and the third carrier is perpendicularly provided at a second end of the second carrier; and the plurality of 3D antennas are provided spaced apart along the first carrier, the second carrier and the third carrier.

8. The 3D wireless multiband antenna of claim 7, wherein a first end of the audio assembly is provided with a first fastening hole, and a second end of the audio assembly is provided with a second fastening hole; the antenna carrier assembly is provided with a first fastening component and a second fastening component; the first fastening component is provided on an end of the first carrier away from the second carrier; the second fastening component is provided on an end of the third carrier away from the second carrier; the first fastening component is provided in the first fastening hole; and the second fastening component is provided in the second fastening hole.

9. The 3D wireless multiband antenna of claim 1, wherein the antenna carrier assembly is provided with an antenna contact spring; a bottom of each of the plurality of 3D antennas is provided with an antenna feed point; and the antenna feed point is in contact with the antenna contact spring.

10. The 3D wireless multiband antenna of claim 1, further comprising:
an audio alarm;
wherein the audio alarm is provided on the audio assembly.

11. The 3D wireless multiband antenna of claim 10, wherein the audio alarm comprises a resonator, a piezoelectric buzzer and a housing; the resonator is provided on a side of the audio assembly; the piezoelectric buzzer is provided on a side of the resonator; and the housing is provided between the piezoelectric buzzer and the resonator.
